(19) United States
(12) Patent Application Publication
(10) Pub. No.: US 2023/0366898 A1
(43) Pub. Date: Nov. 16, 2023

(54) DETECTION SYSTEM FOR DETECTING BIOLOGICAL FLUID SAMPLE

(71) Applicant: BIOACES (JIANGSU) LIFE SCIENCE CO., LTD, NANTONG (CN)

(72) Inventors: Ziyin FENG, NANTONG (CN); Minbiao JI, NANTONG (CN); Hao WANG, NANTONG (CN)

(73) Assignee: BIOACES (JIANGSU) LIFE SCIENCE CO., LTD, NANTONG (CN)

(21) Appl. No.: 18/247,038

(22) PCT Filed: Sep. 3, 2021
(86) PCT No.: PCT/CN2021/116503

§ 371 Date: Mar. 29, 2023

(30) Foreign Application Priority Data
Sep. 29, 2020 (CN) 202011052690.7

(51) Int. Cl. G01N 35/02; G01N 35/04; G01N 35/10

(52) U.S. Cl. CPC G01N 35/026; G01N 35/04; G01N 35/1004; G01N 2035/0441; G01N 2035/00356

(57) ABSTRACT

The present disclosure relates to a detection system for detecting a biological fluid sample, which comprises a sampling needle, a consumable, a guide rail system and an optical detection device. The guide rail system comprises a first guide rail and a second guide rail. The detection system further comprises a first drive and a second drive. The sampling needle is movable along the first guide rail between a rest position, a sampling position and a sample discharge position by means of the first drive. In the rest position, the sampling needle is far away from the biological fluid sample to be extracted. In the sampling position, the sampling needle protrudes into the biological fluid sample. The consumable is movable to a plurality of different positions along the second guide rail by means of the second drive, wherein in a first position of the consumable, the sampling needle can discharge the extracted biological fluid sample into a sample receptacle of the consumable in the sample discharge position, and in a second position of the consumable, the biological fluid sample received in the consumable can be detected by the optical detection device. The detection system has a simple structure and a simple workflow.

### TECHNICAL FIELD

The present disclosure relates to a detection system for detecting a biological fluid sample.

### BACKGROUND OF INVENTION

Detection of biological fluid samples may be applied in life science research, biopharmaceuticals, medical diagnosis and so on. A biological fluid sample may be, for example, human blood or animal blood, urine, a body fluid, a plant extract, and may be non-pretreated or pretreated. For example, the number of red blood cells, the number of white blood cells, the activity of cells and so on can be detected for a whole blood sample. For example, the detection of biological fluid samples may relate to applications of molecular diagnosis, immunofluorescence measurement and fluorescent antibody technology and so on.

### SUMMARY OF INVENTION

An object of the present disclosure is to provide a detection system for detecting a biological fluid sample, which has a simple structure and is operatable in a simple workflow.

The object may be achieved by a detection system for detecting a biological fluid sample, which comprises a sampling needle, a consumable, a guide rail system and an optical detection device, wherein the guide rail system comprises a first guide rail for guiding the sampling needle and a second guide rail for guiding the consumable. The detection system further comprises a first drive, by means of which the sampling needle is movable along the first guide rail between a rest position where the sampling needle is far away from the biological fluid sample to be extracted, a sampling position where the sampling needle protrudes into the biological fluid sample, and a sample discharge position. The detection system further comprises a second drive, by means of which the consumable is movable to a plurality of different positions along the second guide rail, wherein in a first position of the consumable, the sampling needle can discharge the extracted biological fluid sample into a sample receptacle of the consumable in the sampling position, and in a second position of the consumable, the biological fluid sample received in the consumable is detectable by the optical detection device.

The detection system according to the present invention may be applied, for example, to molecular diagnosis, immunofluorescence assay and fluorescent antibody technology. The detection system may be applied, for example, to biological science research, biopharmaceuticals, non-medical detection and medical detection. The detection system may be applied, for example, to detect a whole blood sample, a treated biological tissue sample or any other biological fluid samples, especially a human biological fluid sample.

In some embodiments, at least one of the first and the second guide rail may be a linear guide rail.

In some embodiments, the first guide rail may define a linear movement of the sampling needle in a vertical direction.

In some embodiments, the second guide rail may define a linear movement of the consumable in a horizontal direction.

In some embodiments, the detection system may comprise a turntable having a plurality of receptacles, wherein the turntable is rotatable, so that each of the receptacles can be brought to a position corresponding to the sampling position of the sampling needle, wherein each of the receptacles is configured to receive a sample test tube for receiving a biological fluid sample to be detected.

In some embodiments, the sample test tube may be an EP tube embedded with a dye for the biological fluid sample to be detected.

In some embodiments, the turntable may be provided with a controllable turntable drive.

In some embodiments, the turntable may be arranged beside the second guide rail.

In some embodiments, a consumable recovery station and/or the optical detection device may be arranged side by side with the turntable.

In some embodiments, beside the second guide rail, the turntable may be arranged between the optical detection device and the consumable recovery station.

In some embodiments, the turntable may be provided with a sensor for detecting the sample test tube brought to the position corresponding to the sampling position of the sampling needle. A sensor signal of the sensor can be configured for a partially or fully automatic operation of the detection system.

In some embodiments, at least one of the first and the second drive can be activated, deactivated and controlled according to the signal of the sensor.

In some embodiments, the detection system may comprise a controllable syringe pump in fluid connection with the sampling needle, wherein the syringe pump is configured for at least one of the following actions:
dilute the biological fluid sample received in the sample test tube before sampling;
mix the biological fluid sample received in the sample test tube with a dye embedded in the sample test tube before sampling;
extract the biological fluid sample from the sample test tube;
discharge the extracted biological fluid sample into the sample receptacle of the consumable;
flush an inner surface of the sampling needle with a washing fluid;
flush an outer surface of the sampling needle with a washing fluid.

In some embodiments, the detection system may comprise a consumable magazine configured to store a plurality of consumables.

In some embodiments, the consumable magazine may be vertically arranged, wherein the plurality of consumables are received in the consumable magazine in a stack one above the other, wherein the consumable magazine has a consumable extraction output.

In some embodiments, the detection system may comprise a consumable holder which is drivable by the second drive, wherein the consumable holder is configured to extract a consumable to be used from the consumable magazine, wherein the consumable to be used can be kept in the consumable holder after its extraction.

In some embodiments, the consumable can be received in the consumable holder in a releasable manner, wherein one of the consumable holder and the consumable has a spring-loaded locking element, and the other of the consumable holder and the consumable has a locking recess, wherein the locking element can engage into the locking recess and can disengage from the locking recess against a spring-loaded force.

In some embodiments, the consumable holder may be configured, such that a used consumable in the consumable holder is pushed out of the consumable holder by a consumable to be used and drops into the consumable recovery station of the detection system, when the consumable to be used is extracted from the consumable magazine.

In some embodiments, the detection system may comprise a needle washing module having a needle washing channel for the sampling needle to pass through, wherein the sampling needle is movable along the first guide rail by means of the first drive to a needle washing position where an outer surface of a section of the sampling needle to be cleaned can be washed by a washing liquid in the needle washing channel.

In some embodiments, in a movement direction of the sampling needle from the rest position to the sampling position along the first guide rail, the sampling needle may have such a position sequence: the rest position, the needle washing position, the sample discharge position, the sampling position. In the needle washing position, the sampling needle is inserted into or passes through the needle washing channel, and in the sample discharge position and in the sampling position, the sampling needle protrudes through the needle washing channel. In some embodiments, the rest position and the needle washing position may be the same position.

In some embodiments, the needle washing module may have a needle washing liquid circuit configured to introduce a needle washing liquid into an annular gap between the needle washing channel and the sampling needle transversely to an extension direction of the needle washing channel.

In some embodiments, the needle washing liquid circuit may comprise an inlet line leading to the needle washing channel and having at least one line section extending transversely to the extension direction of the needle washing channel, and an outlet line leaving away from the needle washing channel and having at least one line section extending transversely to the extension direction of the needle washing channel, wherein an input opening of the outlet line leaving away from the needle washing channel is lower than an output opening of the inlet line entering the needle washing channel and is higher than a bottom opening of the needle washing channel.

In some embodiments, the detection system may comprise a control system configured to control at least one of all the drives and actuators of the detection system, so that the detection system can partially or fully automatically implement a detection process of the biological fluid sample.

In some embodiments, the detection system may comprise a computer, which is a component of the control system and has a display.

The technical features mentioned above, the technical features to be mentioned below and the technical features shown in the drawings can be arbitrarily combined with each other, only if individual technical features to be combined are not contradictory with each other.

### BRIEF DESCRIPTION OF DRAWINGS

The present invention will be described in more detail by means of specific embodiments with reference to accompanying drawings. In the drawings:

FIG. 1 is a perspective view of a detection system for detecting a biological fluid sample according to an embodiment of the present invention.

FIG. 2 is a partial enlarged perspective view of the detection system of FIG. 1 in a sample discharge position of a sampling needle.

FIG. 3 is a partial enlarged perspective view of the detection system of FIG. 1 before a consumable to be used is extracted.

FIG. 4 is a transparent view of a needle washing module of the detection system of FIG. 1.

### EMBODIMENTS

An embodiment of a detection system for detecting a biological fluid sample is shown in the drawings. The detection system may comprise a table plate 13 and a vertical plate 14 fixedly mounted to the table plate, wherein other components of the detection system may be mounted to the table plate 13 and/or the vertical plate 14.

The detection system may comprise a sampling needle 2 and a first guide rail 1 for guiding the sampling needle 2. The sampling needle 2 may be provided with a needle seat 3 which is movable along the first guide rail 1. In principle, a movement track defined by the first guide rail 1 may be a straight line, a planar curve or a spatial curve. The needle seat 3 may be provided with a first drive 4, such as a step motor, which drives the needle seat 3 and thus drives the sampling needle 2, for example via a lead screw drive. The first guide rail 1 may be particularly a linear guide rail and defines a linear movement of the sampling needle in a vertical direction. The first guide rail 1 may be fixedly mounted to the vertical plate 14. For example, the sampling needle 2 can be moved in a controllable manner to a rest position, a sampling position, a sample discharge position and a washing position on the first guide rail 1 by the controllable first drive 4, wherein the washing position and the rest position may be the same position or may be different positions. The sampling needle 2 may be in fluid connection with a syringe pump 20 to be described in detail later, so as to realize various functions of the sampling needle 2.

The detection system may comprise consumables 16 and a second guide rail 6 for guiding a respective consumable. The second guide rail 6 may be, for example, a linear guide rail defining a linear movement of the consumable 16 in a horizontal direction. Alternatively, the second guide rail 6 may also be a curved guide rail. The second guide rail may be fixedly mounted to the table plate 13. The consumables 16 may be associated with a consumable holder 9, which may be guided on the second guide rail 6 and may carry a respective consumable 16. The consumable holder 9 may be provided with a second drive 12, which can drive the consumable holder 9 to move along the second guide rail 6. The second drive 12 may be, for example, a step motor, which can drive the consumable holder 9, for example by means of a lead screw drive.

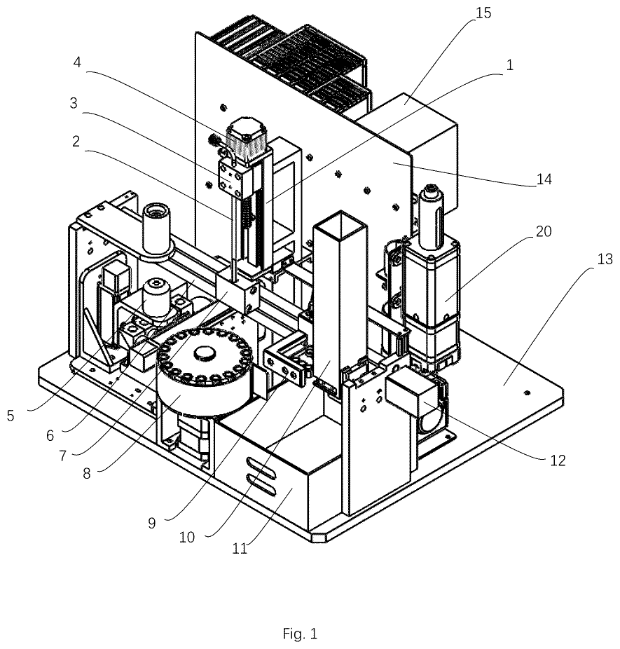

The detection system may comprise a consumable magazine 10 in which a plurality of consumables 16 are stacked in a vertical direction. The consumable magazine has a consumable extraction output at its bottom. The consumable holder 9 movably guided on the second guide rail 6 can be moved to the consumable extraction output of the consumable magazine 10, and can releasably engage with the lowest one consumable 16 to be used in the consumable extraction output, and then the consumable holder 9 together with this consumable 16 to be used can leave away from the consumable extraction output of the consumable magazine 10 along the second guide rail 6. FIG. 3 is a partial enlarged perspective view of the detection system of FIG. 1 before the consumable 16 to be used is extracted. In FIG. 3, the consumable holder 9 is empty and is about to be inserted into the consumable extraction output of the consumable magazine 10. When the one consumable in the consumable extraction output is extracted, the remaining consumables above this one consumable drop off under the action of gravity, so that a next one consumable reaches the consumable extraction output. If there is a used consumable in the consumable holder 9 before the consumable 16 to be used is extracted, then during an extraction process, the used consumable can be pushed out of the consumable holder 9 by the consumable 16 to be used and drops into a consumable recovery station 11 below the consumable magazine 10. For this purpose, a consumable 16 can be received in the consumable holder 9 in a releasable manner, wherein one of the consumable holder 9 and the consumable 16 may have a spring-loaded locking element 24, and the other of the consumable holder 9 and the consumable 16 may have a locking recess 26, wherein the locking element 24 can engage into the locking recess 26 and can disengage from the locking recess 26 against a spring-loaded force. In the embodiment shown in FIG. 3, the consumable holder 9 has two rows of locking elements 24, and the consumable 16 has two rows of locking recesses 26 at two sides.

Each consumable 16 may have a plurality of sample receptacles 22 and a corresponding number of ventilation holes 23. In the embodiment shown in FIG. 3, the consumable 16 may have three sample receptacles 22 and three ventilation holes 23. The sampling needle 2 may discharge the extracted biological fluid sample into one of the unused sample receptacles 22 of the consumable 16, and respective one of the ventilation holes 23 can ensure that the biological fluid sample normally flows into this sample receptacle 22. If all the sample receptacles 22 of the consumable have been used, then the used consumable is recovered, and a new consumable to be used is extracted again.

The detection system may comprise a turntable 8. The turntable 8 may be arranged beside the second guide rail 6. An optical detection device 5 may be arranged side by side with the turntable 6, and is configured to optically detect the biological fluid sample in the consumable 16 transported by the consumable holder 9 along the second guide rail 6. The optical detection device 5 may comprise a group of optical lenses and a camera. An image shot by the camera can be processed by means of an image processing device.

The turntable 8 may comprise a plurality of receptacles 21, which may be uniformly distributed on a circle, for example. The turntable 8 is rotatable, so that each of the receptacles 21 can be brought to a position corresponding to the sampling position of the sampling needle 2. Each of the receptacles 21 is configured to receive a sample test tube for receiving a biological fluid sample to be detected. The sample test tube may be, for example, an EP tube embedded with a dye for the biological fluid sample to be detected. The turntable 8 may be provided with a controllable turntable drive, so that the turntable 8 is operatable automatically. The turntable 8 may be provided with a sensor for detecting the sample test tube brought to the position corresponding to the sampling position of the sampling needle 2, wherein a sensor signal of the sensor may be used for a partially or fully automatic operation of the detection system, such as for automatically mixing, extracting, discharging the sample, for an automatic operation of the first and the second drive, and the like.

The detection system may comprise a controllable syringe pump 20 in fluid connection with the sampling needle 2, wherein the syringe pump is configured for at least one of the following actions:
dilute a biological fluid sample received in a sample test tube before sampling;
mix the biological fluid sample received in the sample test tube with a dye embedded in the sample test tube before sampling;
extract the biological fluid sample from the sample test tube;
discharge the extracted biological fluid sample into a sample receptacle 22 of a consumable 16;
flush an inner surface of the sampling needle 2 with a washing fluid;
flush an outer surface of the sampling needle 2 with a washing fluid.

Preferably, all the above-mentioned actions are realized by means of the syringe pump 20, which may be beneficial to a fully automatic operation of the detection system.

The detection system may comprise a needle washing module 7 having a needle washing channel 17 for the sampling needle to pass through. The sampling needle 2 is movable to a needle washing position along the first guide rail 1 by means of the first drive 4. The needle washing position may be the same as or different from the rest position. In the needle washing position, an outer surface of a section of the sampling needle 2 to be cleaned can be washed by a washing liquid in the needle washing channel 17. In a movement direction of the sampling needle 2 from the rest position to the sampling position along the first guide rail 4, the sampling needle may have such a position sequence: the rest position, the needle washing position, the sample discharge position and the sampling position, wherein the sampling needle 2 is inserted into or passes through the needle washing channel 17 in the needle washing position, and the sampling needle 2 protrudes through the needle washing channel in the sample discharge position and in the sampling position. It can be understood that the needle washing position may be a fixed position of the sampling needle 2 or a stroke of the sampling needle 2. For the sake of simplicity, fluid pipes connected to the needle washing module 7 are not shown in the drawings.

FIG. 1 is a perspective view of the detection system in an operation state. Here, a biological fluid sample to be detected may be received in an EP tube. At least one EP tube may be inserted into the receptacles 21 of the turntable 8. When the sensor detects that an EP tube is in a position corresponding to the sampling position of the sampling needle 2, the first drive 4 for the sampling needle 2 can be controlled to move the sampling needle 2 to the sampling position, in particular from the rest position to the sampling position. In the state shown in FIG. 1, the second drive 12 for the consumable holder 9 can be controlled so as to ensure that the consumable holder 9 does not interfere with the movement of the sampling needle 2. Typically, for this purpose, the consumable holder 9 can be kept in or can be moved to a position adjacent to the consumable magazine 10.

In some embodiments, before the biological fluid sample is extracted, it may be necessary to mix and/or dilute the biological fluid sample to be detected. For this reason, the syringe pump 20 can be operated, so that the biological fluid sample to be detected can be evenly mixed in the sample test tube by means of a reciprocating suction of the syringe pump 20. Alternatively or additionally thereto, the sampling needle 2 can also be controlled to be in a vibration state, wherein the biological fluid sample to be detected can be evenly mixed in the sample test tube by means of the vibration of the sampling needle 2. In order to dilute the biological fluid sample to be detected, a dilution fluid, such as water or ethanol, can be fed to the sample test tube by means of the syringe pump 20.

In some embodiments, a sample test tube, such as an EP tube, may be embedded with a dye. Bay a mixing operation, the dye can be dissolved in the biological fluid sample to be detected, and both mix evenly with each other. For the dye embedment, two examples are introduced below.

### Example 1: Embedment of a Bright-Field Dye

Active dyes used in a bright-field detection commonly may be trypan blue, methylene blue, crystal violet, etc. Active dyes may be different in different preferable embodiments.

In some preferable embodiments, an active dye may be trypan blue. The trypan blue may be used to selectively dye dead tissues or cells blue. Living cells or tissues with intact cell membranes are not dyed. The trypan blue isn't absorbed into living cells because these cells are selective for compounds that pass through the cell membranes. However, the trypan blue can pass through the cell membranes of the dead cells and thus provide distinctive dead cells that are dyed blue.

The trypan blue powder is difficult to be fully dissolved in an aqueous solution or in a culture medium. If the trypan blue powder is directly embedded at a bottom of an EP tube, and it's mixed with the cell suspension, it's possible that an expected concentration of the trypan blue can't be achieved, and the concentration may be affected by powdery substances. By the way that the trypan blue in a high concentration is completely dissolved in some non-toxic and non-volatile organic solvents and then it's arranged at a bottom of a specific EP tube, an excellent performance of the pre-embedment of the trypan blue dye can be realized.

When fresh CHO and/or 293 cells are collected from a cell culture bottle or a bioreactor, and a fixed volume of cells is mixed with the embedded trypan blue dye, an operation concentration of the trypan blue dye in this system is expected and certain, and the cells can be sufficiently dyed under the actual trypan blue concentration. The cells are shifted to a sample room of a consumable, and then images are shot, and then the counted images are used to identify and determine various cell states according to an algorithm, so that accurate results of the activity of the cells can be directly calculated.

### Example 2: Embedment of Fluorescent Dye

For optimization of tests for determination of livability and death rate of cells and so on, a fluorescent dye may selectively determine whether cells are alive or dead or dying, and should be bright and have a low background signal. Common acridine orange (AO), DAPI, Hoechst, SYTO9, etc. can dye all the cells, while propidium iodide (PI), ethidium bromide (EB), 7-AAD, etc. can enter cells with damaged cell membranes. For each dye, a series of tests are carried out with a series of concentration values under various dye formulations, and then an optimal concentration value and an optimal formulation of the dye can be determined.

An exemplary operation process of the detection system shown in FIG. 1 is described below.

Firstly, the detection system is powered on, wherein all the movable parts of the detection system may be moved to their respective initial positions. At least one sample test tube is inserted into the respective receptacles 21 of the turntable 8. Then a start button is pressed to start a detection process. The sampling needle 2 can be moved from a rest position to a sampling position where a needle tip of the sampling needle 2 protrudes into the sample test tube. If necessary, before sampling, the biological fluid sample to be detected is diluted and/or mixed by means of the sampling needle 2 and the syringe pump 20 in fluid connection with the sampling needle, and then the biological fluid sample is extracted.

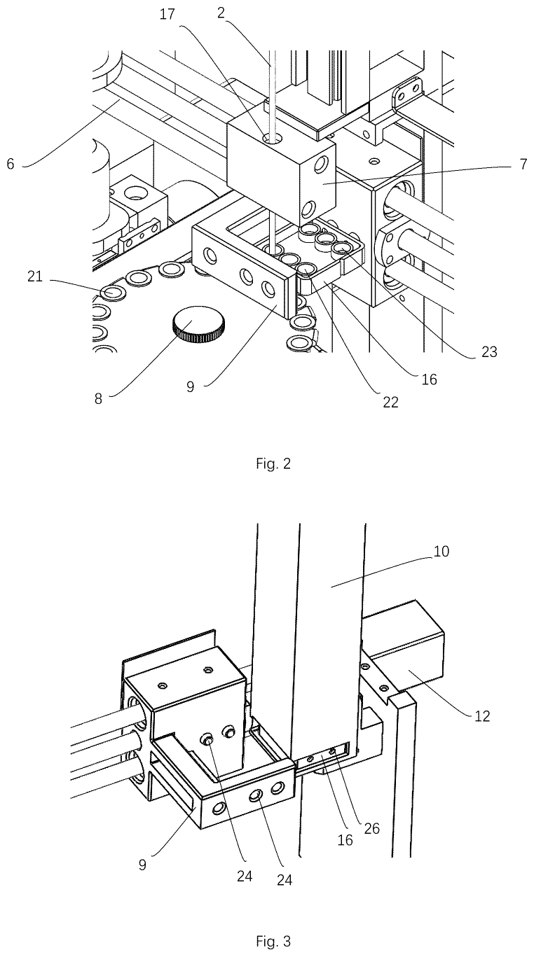

After sampling, the sampling needle 2 can return to a position far away from the sampling position, in particular to the rest position. Then, the consumable 16 and the consumable holder 9 can be moved by means of the second drive 6, so that one of the sample receptacles 22 of the consumable 16 is brought to a position corresponding to the sample discharge position of the sampling needle 2. Then, by the control of the first drive 4, the sampling needle 2 can be moved along the first guide rail 1 to the sample discharge position where the needle tip of the sampling needle 2 protrudes into the one sample receptacle 22 and the extracted biological fluid sample is discharged into the one sample receptacle 22. FIG. 2 shows the sampling needle 2 in the sample discharge position.

After discharging the sample, the sampling needle 2 can leave away from the sample discharge position, especially return to the rest position, so that the consumable holder 9 together with the consumable 16 can be moved to the optical detection device 5 by the control of the second drive 6, wherein in the optical detection device an optical detection of the biological fluid sample is carried out.

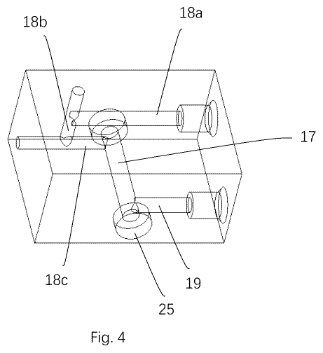

If an outer surface of the sampling needle 2 should be cleaned, the sampling needle 2 can be moved to the needle washing position by the control of the first drive 4. The needle washing position may be the same as or different from the rest position. In the needle washing position, an outer surface of a section of the sampling needle 2 to be cleaned can be washed in the needle washing channel 17 of the needle washing module 7. The needle washing module 7 has a needle washing liquid circuit configured to introduce a needle washing liquid into an annular gap between the needle washing channel 17 and the sampling needle 2 transversely to an extension direction of the needle washing channel. For example, the needle washing liquid circuit may comprise an inlet line leading to the needle washing channel 17 and having at least one line section 18a, 18b, 18c extending transversely to the extension direction of the needle washing channel 17, and an outlet line leaving away from the needle washing channel 17 and having at least one line section 19 extending transversely to the extension direction of the needle washing channel 17. As shown in FIG. 4, an input opening of the outlet line leaving away from the needle washing channel 17 (or an input opening of the line section 19) is lower than an output opening of the inlet line leading into the needle washing channel 17 (or an output opening of the line section 18c), and is higher than a bottom opening 25 of the needle washing channel. An inner surface of the sampling needle 2 can be washed by means of the syringe pump 20.

The detection system may comprise a control system 15, which is configured to control at least one of all the drives and actuators of the detection system, so that the detection system can partially or fully automatically implement a detection process of a biological fluid sample. In particular, the detection system may comprise a computer, which is a component of the control system and has a display. For example, detection process parameters and detection results may be displayed on the display.

It should be noted, terms are used only for the purpose of describing specific aspects, and are not used to limit the scope of disclosure. As used herein, the singular forms “a” and “the” should comprise plural forms, only if the context doesn't indicate oppositely. It can be understood that the terms “comprising” and “including” and other similar terms, when used in the application document, specify the existence of stated operations, elements and/or components, but do not exclude the existence or addition of one or more other operations, elements, components and/or their combinations. The term “and/or” in the application comprises all arbitrary combinations of one, two or more related listed items. In the description of the drawings, the same reference numerals may represent the same elements.

The thickness of elements in the drawings may be exaggerated for clarity. In addition, it can be understood that if an element is mounted, coupled or connected to another element, it may be directly mounted, coupled or connected to the other element, or there may be one or more intermediate elements between them. On the contrary, if the expressions “directly mounted to”, “directly coupled to” and “directly connected to” are used here, it means that there are no intermediate elements. Other words for describing the relationship between elements should be interpreted similarly, such as “between” and “directly between”, “attached” and “directly attached”, “adjacent” and “directly adjacent”, and so on.

Terms such as “top”, “bottom”, “above”, “below” are used here to describe the relationship of one element, layer or region with respect to another element, layer or region as shown in the drawings. It can be understood that these terms should also comprise other orientations of the device besides those shown in the drawings.

It can be understood that although the terms “first”, “second” and the like may be used herein to describe different elements, these elements should not be limited by these terms. These terms are only used to distinguish one element from the other. Therefore, a first element may also be called as a second element without departing from the teaching of the present invention.

It would be appreciated that all the exemplary embodiments disclosed herein may be arbitrarily combined with each other.

Finally, it should be pointed out, the above-mentioned embodiments are only for understanding the invention, and do not limit the protection scope of the invention. For those skilled in the art, modifications may be made on the basis of the above embodiments, and these modifications do not depart from the protection scope of the present invention.

1. A detection system for detecting a biological fluid sample, comprising a sampling needle (2), a consumable (16), a guide rail system and an optical detection device (5), characterized in that the guide rail system comprises a first guide rail (1) for guiding the sampling needle and a second guide rail (6) for guiding the consumable,
wherein the detection system further comprises:
a first drive (4), by means of which the sampling needle is movable along the first guide rail between a rest position where the sampling needle is far away from the biological fluid sample to be extracted, a sampling position where the sampling needle protrudes into the biological fluid sample, and a sample discharge position; and
a second drive (12), by means of which the consumable is movable to a plurality of different positions along the second guide rail, wherein in a first position of the consumable the sampling needle can discharge the extracted biological fluid sample into a sample receptacle (22) of the consumable in the sample discharge position, and in a second position of the consumable the biological fluid sample received in the consumable can be detected by the optical detection device.

2. The detection system as recited in claim 1, characterized in that at least one of the first and the second guide rail is a linear guide rail.

3. The detection system as recited in claim 2, characterized in that the first guide rail defines a linear movement of the sampling needle in a vertical direction.

4. The detection system as recited in claim 2, characterized in that the second guide rail defines a linear movement of the consumable in a horizontal direction.

5. The detection system as recited in any one of claims 1 to 4, characterized in that the detection system comprises a turntable (8) having a plurality of receptacles (21), wherein the turntable is rotatable, so that each of the receptacles can be brought to a position corresponding to the sampling position of the sampling needle, wherein each of the receptacles is configured to receive a sample test tube for receiving a biological fluid sample to be detected.

6. The detection system as recited in claim 5, characterized in that the sample test tube is an EP tube embedded with a dye for the biological fluid sample to be detected.

7. The detection system as recited in claim 5, characterized in that the turntable is provided with a controllable turntable drive.

8. The detection system as recited in claim 5, characterized in that the turntable is arranged beside the second guide rail.

9. The detection system as recited in claim 5, characterized in that the turntable is provided with a sensor for detecting the sample test tube brought to the position corresponding to the sampling position of the sampling needle, wherein a sensor signal of the sensor is configured for a partially or fully automatic operation of the detection system.

10. The detection system as recited in claim 9, characterized in that at least one of the first and the second drive can be activated, deactivated and controlled according to the signal of the sensor.

11. The detection system as recited in any one of claims 1 to 4, characterized in that the detection system comprises a controllable syringe pump (20) in fluid connection with the sampling needle, wherein the syringe pump is configured for at least one of the following actions:
dilute a biological fluid sample received in a sample test tube before sampling;
mix the biological fluid sample received in the sample test tube with a dye embedded in the sample test tube before sampling;
extract the biological fluid sample from the sample test tube;
discharge the extracted biological fluid sample into a sample receptacle of the consumable;
flush an inner surface of the sampling needle with a washing fluid;
flush an outer surface of the sampling needle with a washing fluid.

12. The detection system as recited in any one of claims 1 to 4, characterized in that the detection system comprises a consumable magazine (10) configured to store a plurality of consumables.

13. The detection system as recited in claim 12, characterized in that the consumable magazine is vertically arranged, wherein the plurality of consumables are received in the consumable magazine in a stack one above the other, wherein the consumable magazine has a consumable extraction output in a lower end region.

14. The detection system as recited in claim 12, characterized in that the detection system comprises a consumable holder (9), which is drivable by the second drive, and which is configured to extract a consumable to be used from the consumable magazine, wherein the consumable to be used can be kept in the consumable holder after its extraction.

15. The detection system as recited in claim 14, characterized in that a consumable is receivable in the consumable holder in a releasable manner, wherein one of the consumable holder and the consumable has a spring-loaded locking element (24), and the other of the consumable holder and the consumable has a locking recess (26), wherein the locking element can engage into the locking recess and can disengage from the locking recess against a spring-loaded force.

16. The detection system as recited in claim 15, characterized in that the consumable holder is configured, such that a used consumable in the consumable holder is pushed out of the consumable holder by a consumable to be used and drops into a consumable recovery station (11) of the detection system when the consumable to be used is extracted from the consumable magazine.

17. The detection system as recited in any one of claims 1 to 4, characterized in that the detection system comprises a needle washing module (7) which has a needle washing channel (17) for the sampling needle to pass through, wherein the sampling needle is movable along the first guide rail by means of the first drive to a needle washing position where an outer surface of a section of the sampling needle to be cleaned can be washed by a washing liquid in the needle washing channel.

18. The detection system as recited in claim 17, characterized in that in a movement direction of the sampling needle from the rest position to the sampling position along the first guide rail, the sampling needle has such a position sequence: the rest position, the sample discharge position and the sampling position, wherein in the needle washing position the sampling needle is inserted into or passes through the needle washing channel, and in the sample discharge position and in the sampling position, the sampling needle protrudes through the needle washing channel, wherein the needle washing position is the same as the rest position, or the needle washing position lies between the rest position and the sample discharge position.

19. The detection system as recited in claim 17, characterized in that the needle washing module has a needle washing liquid circuit configured to introduce the needle washing liquid into an annular gap between the needle washing channel and the sampling needle transversely to an extension direction of the needle washing channel.

20. The detection system as recited in claim 19, characterized in that the needle washing liquid circuit comprises an inlet line and an outlet line, wherein the inlet line leads to the needle washing channel and has at least one line section (18a, 18b, 18c) extending transversely to the extension direction of the needle washing channel, wherein the outlet line leaves away from the needle washing channel and has at least one line section (19) extending transversely to the extension direction of the needle washing channel, wherein an input opening of the outlet line leaving away from the needle washing channel is lower than an output opening of the inlet line entering the needle washing channel and is higher than a bottom opening (25) of the needle washing channel.

21. The detection system as recited in claim 1 or 2, characterized in that the detection system comprises a control system (15) configured to control at least one of all the drives and actuators of the detection system, so that the detection system can partially or fully automatically implement a detection process of the biological fluid sample.

22. The detection system as recited in claim 21, characterized in that the detection system comprises a computer, which is a component of the control system and has a display.
